(19) United States
(12) Patent Application Publication
(10) Pub. No.: US 2009/0211147 A1
(43) Pub. Date: Aug. 27, 2009

(54) ANIMAL EUTHANASIA BY ELECTROCUTION

(76) Inventors: Martine Denicourt, Ste-Cecile de Milton (CA); Christian Klopfenstein, Saint-Pie (CA)

Correspondence Address: ADE & COMPANY INC., 2157 Henderson Highway, WINNIPEG, MB, R2G1P9, CA

(21) Appl. No.: 12/364,097

(22) Filed: Feb. 2, 2009

Related U.S. Application Data
(60) Provisional application No. 61/025,269, filed on Jan. 31, 2008.

(51) Int. Cl. A01M 23/38; A01K 15/04

(52) U.S. Cl. 43/98; 119/417; 119/751

(57) ABSTRACT

Apparatus for euthanasia of animals by electrocution includes a container on wheels formed of an electrically insulating material and a rechargeable 12V battery powered control unit carried on the container for supplying through a transformer AC electric current at 110V to electrodes through insulated electrical supply cables. The first electrode is a conductive wire forming a loop arranged to be wrapped around the snout and through the mouth of the animal. The second electrode is a belt shaped and arranged to wrap around the belly of the animal at a position just in front of the rear legs. An alternative second electrode may be a rectal probe. Each of the electrodes is attached to a winch by which it can be pulled to apply tension electrode during the electrocution. In a second arrangement the control unit and the electrodes are arranged to be hand carried to the animal.

This application claims the benefit under 35 U.S.C. 119 of Provisional Application No. 61/025,269 filed Jan. 31, 2008.

This invention relates to an apparatus for use in animal euthanasia by electrocution.

### BACKGROUND OF THE INVENTION

Many patented proposals have been made for the use of electricity to stun animals in a slaughterhouse where the animal must be stunned for humanitarian reasons prior to killing by other means for use of the meat. However this is not the same process as euthanasia where the animal is required to be killed, generally in circumstances where the meat cannot be used and the carcass must be disposed of.

There are a number of patents on techniques for euthanasia which provide many different techniques, but electrocution is not proposed.

Most official methods proposed to the farmers for euthanasia cause a cranial traumatism. This method even though its acceptable for the well-being of the animal but is traumatizing for the workers in view of the blood flow.

In the industry, pork producers sometimes euthanize using 110V for electrocution of pigs for the well-being of the pigs (for example weak or sick pigs). In practice, euthanizing by electrocution has been practiced by a lot of farmers using the 110V supply voltage. However this is not recognized and is considered dangerous. Briefly, the technique consists in modifying and using automobile jumper cables. The farmer installs a 110V supply across one of the ends of the cable and attaches the other end on the head and tail of the pig. This technique has the following problems:

The jumper cables are built for 12V and not 110V;

The jumper cables are painful to the animal and not easy to attach;

The direct connection in the electrical circuit without any element of protection and where the animal is unrestrained is dangerous for the user;

The results of euthanizing by electrocution in this manner are uncertain in some cases failing to cause immediate death leaving the animal to suffer.

### SUMMARY OF THE INVENTION

It is one object of the invention to provide an apparatus for euthanizing by electrocution sick and non-ambulatory pigs at the farm that respects well-being standards for the pigs and is acceptable for the users.

According to one aspect of the invention there is provided an apparatus for euthanasia of animals comprising:

a first electrode for engaging the animal at a first location;

a second electrode for engaging the animal at a second location;

and an electrical supply control unit for supplying electric current to the electrodes through electrical supply cables;

wherein first electrode is shaped and arranged to be located in the mouth of the animal.

Preferably the first electrode is a conductive member arranged to be wrapped around the snout and through the mouth of the animal.

Preferably the conductive member forms a loop which can be tightened around the snout of the animal.

Preferably the second electrode is a probe for insertion into the rectum of the animal.

Preferably the second electrode is a belt which is shaped and arranged to wrap around a body part of the animal and preferably around the belly of the animal just in front of the rear legs.

Preferably the belt includes a cinch to tighten around the body part of the animal.

The belt may be formed of a wire mesh or other conductive material. However other constructions are preferred since wire mesh can corrode and can become distorted and bent after repeated use. A belt formed by a plurality of side by side stainless steel wires clamped together by bridging clamping members can be suitable but other constructions are possible. The use of a belt which can be of the order of 1 to 2 inches in width is suitable to provide sufficient contact area to ensure current flow without burning at the skin.

Preferably at least one of the electrodes is attached to a pulling device such as a winch for pulling the electrode to apply tension to the electrode to tension the electrode on the animal. Each electrode can be connected to a respective one of a pair of winches to apply tension in the forward direction at the first electrode in the mouth and in the upward direction at the second electrode around the belly of the animal, just in front of the hind legs. Alternatively a single winch can be used either at the first or second electrode with the other electrode being attached to a holding member which holds it fixed against tension from the other electrode. The term winch as used herein can include mechanically or electrically driven winches or simple hand cranks which apply a pulling action on the electrode. Other pulling devices with apply a tension to an element attached to the electrode can be used such as a simple spring where the element to be tensioned is hooked onto the spring when the tension is required.

Preferably the first electrode is attached at the head area of the animal and is pulled forwardly and the second electrode is attached around the body of the animal and is pulled upwardly.

Preferably the independent electrical supply control unit comprises a battery such as a 12V or 24V battery and a transformer for receiving the current from the battery and for generating the required voltage to be applied to the electrodes. However the use of a battery is not essential and the device may be operated solely by current from a mains supply. In this case, the mains supply is separated from the current supplied across the electrodes by a transformer so that the euthanizing current is isolated from the mains supply. This avoids any current being lost by leaking to ground and provides increased safety for the worker.

Preferably the voltage applied to the electrodes is AC at least 110V but can be higher.

In one embodiment the electrical supply control unit is carried on a movable transport device carried on wheels and includes a battery charger for charging the battery from a mains supply.

The movable unit thus includes a first component for engaging the animal with the electrodes and the control unit for supplying the current both of which can be moved from place to place as a common structure to take the device to the animal to be euthanized.

As an alternative, the structure may be arranged to be stationary within a hog facility with the intention that the animals are brought to the device to the euthanizing action. In this case a battery may be omitted.

Preferably the electrical supply control unit includes two switches which must be activated simultaneously for supplying electric current to the electrodes so as to require two hand operation by the operator.

Preferably the device includes a container for receiving and enclosing the animal for euthanasia, the container having upstanding side walls and optionally a top and a base, all of which can be formed of an electrically insulating material for containing the animal during electrocution. A fold out ramp can also be provided to assist in leading the animal without difficulty onto the floor or base of the container.

The container preferably has a closed top to ensure safety to the operator but the top may have openings or transparent portions to allow viewing of the animal during the procedure.

Preferably there is provided a winch on the container connected to one of the electrodes for pulling on the animal during electrocution. The winch can be arranged to pull forward on a forward electrode or upwardly on a rear electrode or two winches can be provided to apply both actions.

However in a first alternative construction, there may be no container and the device comprises a hand carried device including the control unit as one element and a stand for resting on the ground and for applying a pulling force on one of the electrodes for tensioning the electrode on the animal. The stand carries one of the electrodes and one of the winches. A second winch may be provided at the control unit. This is particularly designed for a situation where the animal is very large and cannot be moved into a container because it is too sick or is non-cooperative. This device is suitable for an animal which can be manipulated to wrap the belly electrode around the belly from the stand.

As an alternative particularly for use with larger animals which are very weak and cannot stand, the second electrode can comprise a metal probe which is inserted into the rectum. This provides good electrical connection and can be readily inserted even when the animal is lying inert.

According to a second aspect of the invention there is provided an apparatus for euthanasia of animals comprising:

a portable container for receiving the animal for euthanasia;

a first electrode for engaging the animal at a first location;

a second electrode for engaging the animal at a second location;

and an electrical supply control unit for transportation with the container for supplying electric current to the electrodes through electrical supply cables;

the container having upstanding side walls formed of an electrically insulating material for containing the animal during electrocution.

According to a third aspect of the invention there is provided an apparatus for euthanasia of animals comprising;

a first electrode for engaging the animal at a first location;

a second electrode for engaging the animal at a second location;

and an electrical supply control unit for supplying electric current to the electrodes through electrical supply cables;

wherein at least one of the electrodes is attached to a winch for pulling the electrode to apply tension on the electrode for tightening the electrode on the animal.

The arrangement described hereinafter therefore may have the following important new features:

The electrodes can be easily located in the mouth and on the belly just in front of the rear legs;

As an alternative a rectal probe is equally effective to the belly strap;

The device is isolated from a mains supply circuit by a battery and/or by a transformer;

There is provided a cage or container which can be electrically insulated and safe for the user.

The battery supply and/or transformer is designed to isolate the electrocution device from mains supply system to insure the safety of the user and the efficiency of electrocution so that there is no loss of current into the ground.

The electrodes used for connection and contact comprise preferably a steel wire (⅛″ or 3/16″) for engagement through the mouth, and a body belt. Different shapes and arrangement of the electrodes can be provided with the intention that the first electrode engages into the mouth and the second provides a belt or band of a large contact area for engagement around the belly just in front of the rear legs.

This device preferably uses a battery to generate the voltage required to euthanize the animal where mains supply is not accessible.

This technique permits efficient euthanizing of pigs of all different sizes including those which are just born, finishing pigs and older sows and boars.

The method permits the euthanizing of the pigs without failures leading to harming them or unnecessary suffering.

The euthanizing method using electrocution permits the euthanizing of the pigs without blood flow. The technique is very clean, which makes the euthanizing by electrocution more acceptable by the users and for the public.

The apparatus described hereinafter may meet one or more of the following criteria:

Rapid loss of consciousness;

Sudden death;

Minimum of immobilization and excitement;

Adaptable to age of the animal, species and state of health;

Minimum stress for the animal;

Efficient and irreversible;

Simple to operate;

Safe for the user;

Esthetic and non-traumatizing for the user;

Death without unnecessary suffering;

The animal is easily immobilized;

No mark on the animal at the contact point of the electrodes during the electrocution;

No blood flow, a clean technique appreciated by the users;

No movement at the end of the electrocution by the animal.

This arrangement described herein is mainly proposed to euthanize pigs in situations that do not require conservation and optimization of the quality of the meat. This invention is a suitable tool for euthanizing the sick or non-ambulatory pigs at the farm, and pigs that are in pathology laboratories and that are used in research protocols.

The arrangement described herein can be used for piglets in nurseries (up to 25 kg) and for slaughter pigs (25-110 kg). The technique can be used for adult animals including sows and boars used in breeding and in boar studs.

Although the arrangement described herein has been developed for the pigs, it can be used on other animals.

The importance of the location and tension on electrodes on the animal is to insure a maximum transmission of electricity to diminish impedance. The apparatus provides a first electrode on a mucus membrane which is a steel wire in the mouth and the second electrode is on the surface of the animal which is a wire mesh belt around the girth, just in front of the hind legs. Since the contacts are good and the voltage low it does not burn the animal at the location of the electrodes.

To diminish the impedance, the arrangement described herein uses a mouth electrode that can be cinched to provide a good contact. The abdominal electrode of the arrangement described herein should also be able to be cinched up tight and also is formed of a wide band of a wire mesh or other belt structure so as to cover a wide enough surface around the animal's girth. If the belt is not tight enough, the electrical transmission is diminished.

There is an advantage to use the electrodes to immobilize the animal.

The electrical generator with a built-in transformer and the isolation of the mains hydro circuit insure the transmission of the voltage without loss of current, which permits a safe manipulation for the user.

### BRIEF DESCRIPTION OF THE DRAWINGS

One embodiment of the invention will now be described in conjunction with the accompanying drawings in which;

FIG. 1 is a side elevational view of one embodiment of the apparatus according to the present invention.

FIG. 2 is an end elevational view of the embodiment of FIG. 1.

FIG. 3 is a schematic circuit layout of the electrical supply control unit of the apparatus of FIG. 1.

FIG. 4 is a schematic illustration of an alternative arrangement which uses a stand in replacement for the container for the animal.

FIG. 5 is a schematic illustration of an alternative arrangement which uses a rectal probe as the second electrode for use with animals which are lying inert.

FIG. 6 is a side elevational view of a further alternative arrangement for transporting the electrical supply unit and the electrodes to an animal to be euthanized.

FIG. 7 is a top plan view of the embodiment of FIG. 6.

In the drawings like characters of reference indicate corresponding parts in the different figures.

### DETAILED DESCRIPTION

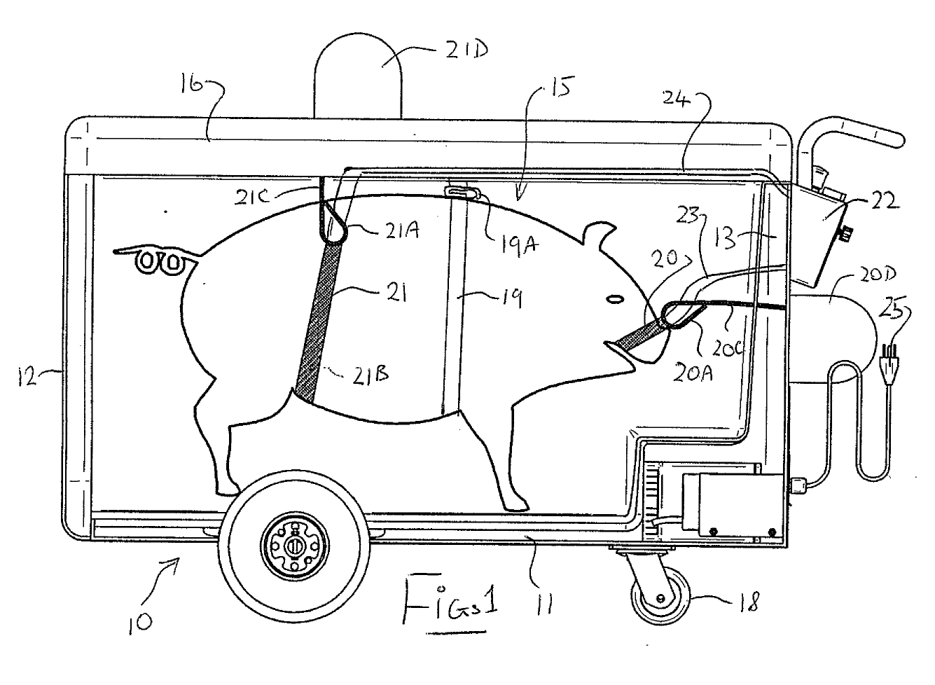

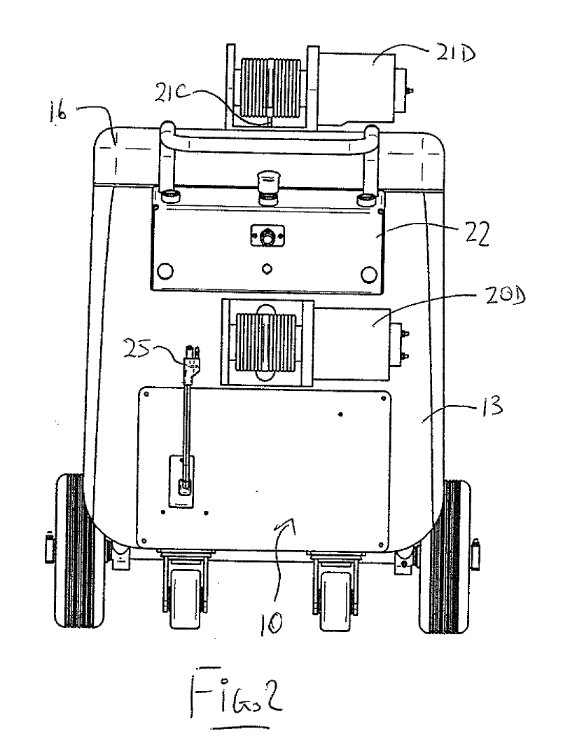

The apparatus shown in FIGS. 1 and 2 for euthanasia of animals includes a container 10 with base 11 and side walls 12 and 13 for the animal 14 during electrocution. An optional folding loading ramp can be included for the animals to enter from floor level onto the base. The container 10 has a closed top 15 to ensure safety of user. The container includes a longitudinally extending support structure 16 for providing support for the animal during the procedure. The container including the base and side walls can be formed of an electrically insulating material so that the animal is isolated from the workers during the procedure.

In order that the container can be readily tailored to match the size of the animal, additional panels can be provided as partition walls or a supplementary floor so that the animal even if small is properly confined.

The container has a door preferably at one end 12 for the animal to be easily lead into the container. The container is carried on wheels 18 for movement from place to place within the hog facility.

The container may have a strap or cable 19 depending from the structure 16 to support the animal in the container from a closed top with the strap being attached to the structure, so that it can be raised and lowered. The non-conductive strap includes a ring 19A so that the strap passes around the animal just behind the front legs and can be cinched up tight to hold and support the animal. Thus the animal is held in place during the procedure.

The apparatus further includes a first electrode 20 for engaging the animal at a first location and a second electrode 21 for engaging the animal at a second location together with an electrical supply control unit 22 for supplying electric current to the electrodes 20 and 21 through insulated electrical supply cables 23 and 24.

The first electrode 20 is located so that it contacts the animal on a mucus membrane preferably located in the mouth and thus the first electrode is in the form of a wire snare or cinch to be wrapped around the snout and through the mouth and to be cinched tight within the mouth using a cinch or loop 20A.

The second electrode is on the outer surface of the animal and contacts the skin in the form of a belt 21 to wrap around the animal and particularly around the girth or belly, just in front of hind legs. The belt can be cinched up by pulling through a loop 21A or by other technique so that it provides effective contact on the skin around the full periphery of the animal. The belt is shown formed of a wire mesh 21B of at least 1.0 inch in width and preferably of the order of 1-2 inches (2.5 to 5 cms) in width. Other constructions and width of the belt can be provided which give a width of contact with the animal sufficient to ensure a required level of conductivity.

The belt 21 is attached to a non-conductive cable 21C of a winch 21D carried on the top 16 or a cross-frame member of the container. The winch cable can be a rope, belt or other non-conductive material. The winch may be driven by electrical or mechanical power or can be a simple hand crank member which allows the cable to be pulled in to apply tension to the electrode. Thus the winch can be operated to pull upwardly on the cable 21C to pull upwardly on the animal as it is contained within the container for the procedure. The tension on the electrode acts to ensure proper contact of the electrodes with the animal and also acts to immobilize the animal to hold it against struggling while the procedure takes place to avoid risk to the operator from contact with the animal.

The wire electrode 20 is attached to a non-conductive cable or strap or rope 20C of a winch 20D carried at a position at the front on a suitable cross-member of the container in front of the front wall 13 of the container. Thus the winch 20D can be operated to pull forwardly on the cable 20C to pull forwardly on the animal as it is contained within the container for the procedure. The two winches thus cooperate to apply a tension to the electrodes between its mouth being pulled forwardly and its belly which is pulled upwardly and thus prevented from moving forwardly. This keeps the animal stationary or immobilized to reduce movement in the animal to reduce the possibility of contact with the operator, and also acts to apply tension to the belt and the wire electrodes to keep them taut.

When the procedure is complete the winches 20D and 21D can be operated in reverse to pay out the cables 20C and 21C to release the tension on the mouth cinch and the belt for both to be removed.

When the procedure is performed, the animal is supported by the second electrode on the cable 21C and can also be supported by the optional strap 19.

When a single winch 21D is used at the cable 21C for applying the tension to the animal, the first contact in the mouth can be simply connected to a front element of the container such as the front panel to locate and immobilize the head of the animal.

The exposed electrical contacts 20 and 21 are contained within the container so that only the insulated cables 23 and 24 and the non-conductive winch cables 20C and 21C connect from inside the container to the elements outside the container including the power supply device 22 so that there is no possibility of the operator inadvertently contacting live contacts during the procedure.

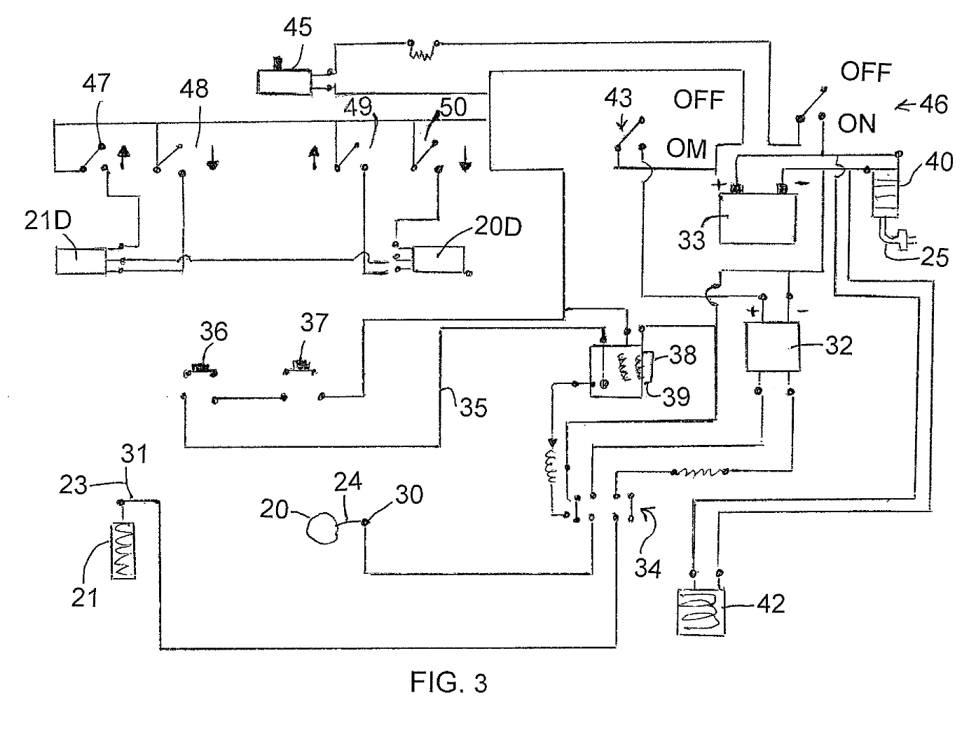

The electrical supply control unit 22 shown in FIG. 3 comprises a first terminal 30 for attachment to the cable 24 leading to the electrode 20 and the second terminal 31 connecting to the cable 23 of the electrode 21. Current across these terminals for supply through the electrodes is provided by a transformer 32 which receives power from a battery 33. The transformer 32 is arranged to convert the 12 volt DC output from the battery 33 into an AC output at a suitable voltage equal to or greater than 110 V which is applied across the terminals 30 and 31. A voltage of 110V has been found suitable to carry out the euthanizing process but higher voltages can be used.

A relay 34 acts to control the supply of the current across the terminals. The relay 34 is activated by current through a circuit 35 which includes two switches 36 and 37 together with a time/voltage modulator 38. In the event that both the switches 36 and 37 are depressed and the modulator remains closed, the circuit 35 acts to pull the relay into conduction thus connecting the current from the transformer across the terminals 30 and 31.

The control unit can also operate without a battery. Thus the mains output is connected directly to the transformer so that the transformer provides isolation between the mains supply and the electrocution circuit. Thus embodiments may be provided where the device is intended to be stationary at a location where mains power is available where there may be no battery needed. Other movable units or hand carried units will in most cases include a battery for full portability.

The two switches 36 and 37 are mounted on the control unit 22 at spaced positions thus requiring both hands of the operator to be in position at the control unit to depress the switch 36 with one hand and the switch 37 with the other hand thus activating the current through the circuit 35. In this way the operator can only activate the electrocution current when the operator has completed all required actions on the animal, the animal is properly connected to the electrodes and the operator has moved to a position at the control unit and has both hands at the control unit. Thus the operator is necessarily removed from the position of electrocution to avoid any possibility of inadvertent contact with the animal during the electrocution process. LEDs are provided at the switches to show that the switches are activated so that the user can see that the two switches are properly activated to initiate the procedure.

A time/voltage modulator 38 is provided which may include an adjustable control 39 which can be adjusted to increase or decrease the amount of time for which the current is caused to flow. In order to avoid the user setting an unsuitable time, the timer control is provided with a number of pre-set values which are selected by the user in dependence on the known approximate weight and/or size of the animal.

It will be appreciated that animals of different age and size require different amounts of current to effect the electrocution. While this may be changed by setting a time of operation, it is better to change the voltage so that a voltage can be set accordingly by the operator again by entering one of a plurality of a preset values prior to activating the switches 36 and 37. Thus the required voltage is set and the modulator automatically comes into conduction when the switches are pressed and remains in conduction until the necessary time has elapsed allowing the modulator to disconnect the circuit and release the relay thus halting the application of the current across the terminals 30 and 31.

There is also provided a main switch 43, which is provided with a key operation to ensure that the device is only used by authorized persons. The key switch 43 is located in the circuit 35 and thus allows the overriding control of the device halting all actions when the main switch is disconnected. Yet further safety switches are provided by a micro switch 45 which is connected to the cover 16 to ensure that the animal is fully contained within the container and all access closed so that the animal is fully enclosed within the non conducting material of the container prior to the activation of the electrocution process. A second emergency OFF switch 46 is provided so that the system can be deactivated instantly in the event of an emergency.

The battery 33 is maintained charged or recharged by a battery charger 40 which can be connected to a main supply when available by a connection plug 25 allowing the device to be disconnected from the main supply and moved from place to place on the cart. A load meter 42 is provided in the charging circuit to confirm that a charging action is occurring and this can be arranged in conventional manner to provide different indications for the charging taking place and for the charging being complete. The load meter is also used to ensure that there is sufficient charge in the battery to complete the procedure so that no procedure is commenced which cannot be completed, potentially leaving the animal to suffer. The battery supply allows the device to be used at all places regardless of the absence of any mains supply. In addition the use of the battery supply and the transformer 32, or the transformer alone, ensures that the connection across the terminals 30 and 31 is entirely separate from the main supply connected to the connector plug 25. There is therefore no possibility of the device interfering with the main supply or of the connection to the main supply causing the current to be halted during an electrocution. All of the current for the electrocution is supplied by the battery which is completely disconnected from the main supply when the electrocution occurs or is supplied by the transformer which ensures that effects at the electrocution circuit are not communicated to the mains circuit, which could trigger a breaker opening or other supply interruption which would halt the procedure when partly complete.

The control unit also provides control for the winches 21D and 20D and includes switches 47 and 48 which control operation of the winch 21D in the tightening and releasing directions respectively and also switches 49 and 50 which similarly control the winch 20D.

The unit 22 thus provides an electrical generator with a built-in transformer which provides isolation from the Mains Supply circuit. The electrical supply control unit 22 insures the transmission of the voltage without loss of current to ground since the animal is directly connected to the positive and negative terminals at the electrodes.

The electrical supply control unit 22 supplies the voltage of the order of 110 to 120 V in North America. The same voltage can be used in other locations where the supply is 220V using a transformer or the voltage applied may be of the order of 220 to 240 V. The system uses the same alternating current supply as the mains supply but acts to isolate the connection to the electrodes from the mains supply.

As stated above, the device may be mounted on wheels for transportation to different locations where the animal to be euthanized is located. Alternatively the device may be stationary at a fixed location so that the animals are lead up to it, depending on the possibility for portability within the facility.

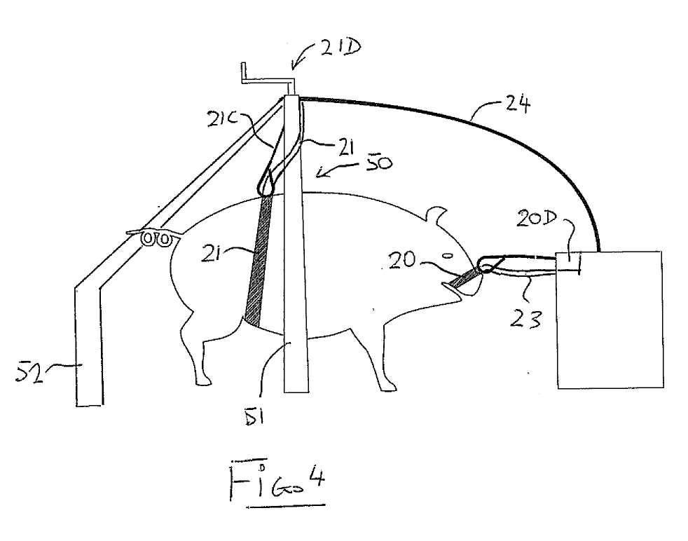

As an alternative, a portable device which does not include the container is shown in FIG. 4. This device carries the electrodes 20 and 21 and the control unit 22 and is manually carried to the animal to be euthanized. The device comprises a stand 50 with a plurality of legs 51 and 52 which stably straddles the rear of the animal to be utilized. The stand can be readily manually carried and manually placed into position with bottom ends and of the legs resting on the ground and the legs converging to an upper support portion held above the ground and above the rear of the animal. The arrangement as shown of the legs is only one example and different two leg or three leg configurations can be used. The control unit 22 can be separate from the stand 50 so as to easily, manually transported to the required location. The arrangement of electrodes 20, 21 and the winches 20D and 21D is substantially as previously described and the procedure is the same. Thus the winch 21D is mounted on the top of the stand 50 and the optional winch 20D is mounted on a suitable support which may be the top of the control unit itself or a carrier for the control unit. The absence of a container allows the device to be used with very large and/or very immobile animals which cannot be lifted into a container or otherwise moved to a required location. A simple plastic sheet can be used if necessary to electrically isolate the animal from its surroundings including the floor and the user.

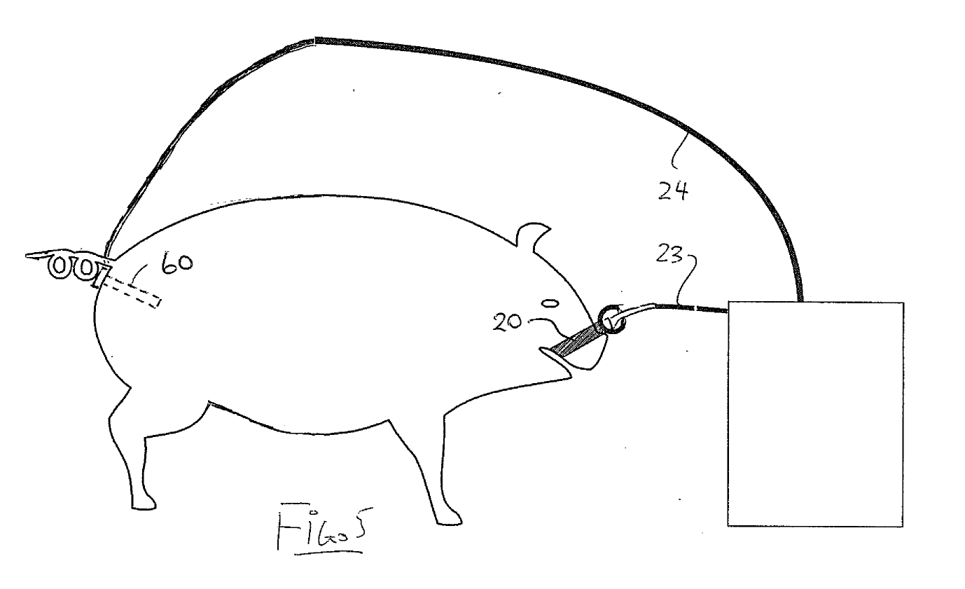

In FIG. 5 is shown a further alternative where the belt type electrode 21 is replaced by a probe 60 in the form of a metal rod which is arranged to be inserted into the rectum of the animal. The electrical connection through the mucus membranes of the mouth and the rectum provide an effective path for the current which has been found to satisfactorily effect the electrocution. The rectal probe can be inserted while an inert animal is lying to avoid the difficulty of lifting the animal to wrap the belt. This arrangement does not provide the stabilizing and restraint effect of the belt and winches but is typically used where these are not required because the animal is inert.

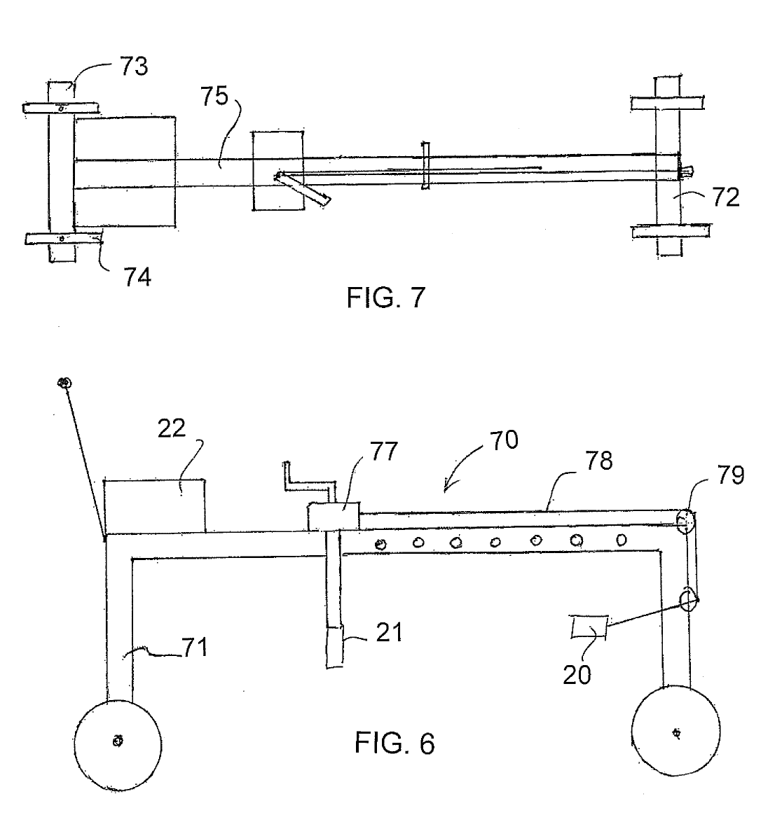

In FIGS. 6 and 7 is shown a further arrangement which can be used in replacement for the construction of FIG. 4 where the electrodes 20 and 21 and the control unit 22 are carried on a wheeled carriage 70. The carriage includes four legs 71 with two front legs attached to an upper front cross-beam 72 and two rear legs attached to a rear cross-beam 73. Each leg carries a wheel 74 which can be a castor wheel if required. The cross-beams are connected by a longitudinal beam 75 which is adjustable in length. A handle 76 at the rear allows the carriage to be pushed to a required location. The simple carriage is very manoeuvrable through narrow alleys. A single crank 77 mounted on the beam 75 above the animal is connected to both electrodes so as to pull upwardly on the electrode 21 and forwardly on the electrode 20 as previously described, the latter running through a cable 78 passing over pulleys 79 on the frame of the carriage. This device is therefore more easily moved than the container of FIG. 1 and yet provides the stabilization of the animal and the tension on the electrodes which is important for safe and effective operation of the electrocution.

Since various modifications can be made in my invention as herein above described, and many apparently widely different embodiments of same made within the spirit and scope of the claims without departing from such spirit and scope, it is intended that all matter contained in the accompanying specification shall be interpreted as illustrative only and not in a limiting sense.

1. Apparatus for euthanasia of animals comprising:
a first electrode for engaging the animal at a first location;
a second electrode for engaging the animal at a second location;
and an electrical supply control unit for supplying electric current to the electrodes through electrical supply cables;
wherein first electrode is shaped and arranged to be located in the mouth of the animal.

2. The apparatus according to claim 1 wherein the first electrode is a conductive member arranged to be wrapped around the snout and through the mouth of the animal.

3. The apparatus according to claim 2 wherein the conductive member forms a loop which can be tightened around the snout of the animal.

4. The apparatus according to claim 2 wherein the second electrode is a probe for insertion into the rectum of the animal.

5. The apparatus according to claim 1 wherein the second electrode is a belt which is shaped and arranged to wrap around the belly of the animal just in front of the rear legs of the animal.

6. The apparatus according to claim 5 wherein the belt includes a cinch to tighten the belt.

7. The apparatus according to claim 1 wherein at least one of the electrodes is attached to a pulling device for pulling the electrode to apply tension to the electrode to tension the electrode on the animal.

8. The apparatus according to claim 7 wherein the first electrode is attached at the head area of the animal and is pulled forwardly and the second electrode is attached around the belly of the animal just in front of the rear legs and is pulled upwardly.

9. The apparatus according to claim 1 wherein the electrical supply control unit comprises a battery and a transformer for generating a required voltage to be applied to the electrodes.

10. The apparatus according to claim 1 wherein the electrical supply control unit comprises a transformer for generating a required voltage to be applied to the electrodes and for isolating the required voltage from the mains supply.

11. The apparatus according to claim 10 wherein the voltage applied to the electrodes is AC of at least 110V.

12. The apparatus according to claim 9 wherein the electrical supply control unit is carried on a portable transport device.

13. The apparatus according to claim 1 wherein the electrical supply control unit includes two switches which must be activated simultaneously for supplying electric current to the electrodes so as to require two hand operation by the operator so that the hands of the operator are occupied on the switches and are therefore away from the electrodes and the animal.

14. The apparatus according to claim 1 wherein there is provided a movable container on wheels for receiving the animal for euthanasia, the container having upstanding side walls for containing the animal during electrocution.

15. The apparatus according to claim 14 wherein the container has a closed top to ensure safety to the operator.

16. The apparatus according to claim 14 wherein there is provided at least one pulling device on the container connected to one of the electrodes for pulling on the animal during electrocution.

17. The apparatus according to claim 1 wherein the electrodes and the electrical control unit are mounted on hand carried components.

18. The apparatus according to claim 17 wherein the hand carried components include a stand for resting on the ground and for applying a pulling force on one of the electrodes for tensioning the electrode on the animal.

19. Apparatus for euthanasia of animals comprising:
a container for receiving the animal for euthanasia;
a first electrode for engaging the animal at a first location;
a second electrode for engaging the animal at a second location;
and an electrical supply control unit for supplying electric current to the electrodes through electrical supply cables;
the container having upstanding side walls for containing the animal during electrocution.

20. Apparatus for euthanasia of animals comprising:
a first electrode for engaging the animal at a first location;
a second electrode for engaging the animal at a second location;
and an electrical supply control unit for supplying electric current to the electrodes through electrical supply cables;
wherein at least one of the electrodes is attached to a pulling device for pulling the electrode to apply tension on the electrode for tightening the electrode on the animal.
